(19) United States
(12) Patent Application Publication
(10) Pub. No.: US 2024/0348527 A1
(43) Pub. Date: Oct. 17, 2024

(54) Signaling Service SID Transposition Capability in SRv6 Networks

(71) Applicant: Ciena Corporation, Hanover, MD (US)

(72) Inventors: Selvamani Ramasamy, Milpitas, CA (US); Muthurajah Sivabalan, Kanata (CA); Lakshmi Rajasekaran, San Jose, CA (US)

(21) Appl. No.: 18/301,699

(22) Filed: Apr. 17, 2023

(51) Int. Cl. H04L 45/02; H04L 45/741; H04L 61/5007

(52) U.S. Cl. CPC H04L 45/04; H04L 45/741; H04L 61/5007; H04L 2101/686

(57) ABSTRACT

Systems and methods for signaling service Segment Identifier (SID) transposition capability in Segment Routing over Internet Protocol version 6 (SRv6) networks include receiving a capability advertisement from a BGP peer where the capability advertisement includes the BGP peer's transposition capability in SRv6 for receiving a given service SID; and advertising a service SID to the BGP peer with transposition based on the capability advertisement of the BGP peer's transposition capability. The steps can further include advertising the BGP's transposition capability to the BGP peer, such that the BGP peer utilizes transposition to the BGP speaker based thereon.

### FIELD OF THE DISCLOSURE

The present disclosure relates generally to networking and computing. More particularly, the present disclosure relates to systems and methods for signaling service Segment Identifier (SID) transposition capability in Segment Routing over Internet Protocol version 6 (SRv6) networks.

### BACKGROUND OF THE DISCLOSURE

Segment Routing, defined in RFC 8402, “Segment Routing Architecture, July 2018, the contents of which are incorporated by reference in their entirety, leverages the source routing paradigm. An ingress node steers a packet through an ordered list of instructions, called “segments.” Segment routing works either on top of a Multiprotocol Label Switching (MPLS) network or on an Internet Protocol version 6 (IPv6) network. In an MPLS network, segments are encoded as MPLS labels. Segment Routing over Internet Protocol version 6 (SRv6) enables a network operator or an application to specify a packet processing program by encoding a sequence of instructions in the IPV6 packet header. For example, SRv6 is described in RFC 8986, “Segment Routing over IPv6 (SRv6) Network Programming,” February 2021, the contents of which are incorporated by reference in their entirety. Under IPv6, a new header called a Segment Routing Header (SRH) is used. Segments in a SRH are encoded in a list of IPV6 addresses.

Border Gateway Protocol (BGP) is used to advertise the reachability of prefixes of a particular service from an egress Provider Edge (PE) to ingress PE nodes. SRv6-based BGP services refer to the Layer 3 (L3) and Layer 2 (L2) overlay services with BGP as the control plane and SRv6 as the data plane. A SRv6 Segment Identifier (SID) is defined in RFC 8402. An SRv6 Service SID refers to an SRv6 SID associated with one of the service-specific SRv6 Endpoint Behaviors on the advertising PE router, such as, but not limited to, End.DT (look up in the Virtual Routing and Forwarding (VRF) table) or End.DX (cross-connect to a next hop) behaviors in the case of L3 Virtual Private Network VPN (L3VPN) service, as defined in RFC 8986.

RFC 9252, “BGP Overlay Services Based on Segment Routing over IPv6 (SRv6),” proposed standard, Sep. 16, 2022, the contents of which are incorporated by reference in their entirety, describes how existing BGP messages between PEs may carry SRv6 Service SIDs to interconnect PEs and form VPNs. RFC 9252 describes mechanisms referred to as “transposition” for the signaling of the SRv6 Service SID by transposing a variable part of the SRv6 SID value and carrying this variable part in existing MPLS Label fields to achieve more efficient packing of those service prefix Network Layer Reachability Information (NLRIs) in BGP update messages.

### BRIEF SUMMARY OF THE DISCLOSURE

The present disclosure relates to systems and methods for systems and methods for signaling service Segment Identifier (SID) transposition capability in Segment Routing over Internet Protocol version 6 (SRv6) networks. The present disclosure includes techniques for a BGP speaker to signal its SRv6 function SID transposition capability, reducing operation overhead with minimal configuration. In some embodiments, the present disclosure includes a method having steps, a Border Gateway Protocol (BGP) speaker configured to implement the steps, and a non-transitory computer-readable medium with instructions that, when executed, cause one or more processors to implement the steps.

The steps include receiving a capability advertisement from a BGP peer where the capability advertisement includes the BGP peer's transposition capability in Segment Routing over Internet Protocol version 6 (SRv6) for receiving a given service Segment Identifier (SID); and advertising a service SID to the BGP peer with transposition based on the capability advertisement of the BGP peer's transposition capability. The steps can further include advertising the BGP's transposition capability to the BGP peer, such that the BGP peer utilizes transposition to the BGP speaker based thereon. The steps can further include failing to receive a second capability advertisement from a second BGP peer where the capability advertisement includes the BGP peer's transposition capability; and advertising the service SID to the BGP peer without transposition based on the failing to receive the second capability advertisement of the second BGP peer's transposition capability.

The capability advertisement can include an Address Family Indicator (AFI), a Subsequent Address Family Indicator (SAFI), and a field indicative of the BGP peer's transposition capability. The capability advertisement can be per RFC 5492. The BGP peer's transposition capability can include whether the BGP peer can process transposed Network Layer Reachability Information (NLRI) entries, can send the NLRIs entries using transposition, and a combination thereof. The steps can further include receiving a second service SID from a second BGP peer with the second service SID having transposition and where the second BGP peer has not provided the capability advertisement of the BGP peer's transposition capability to the BGP speaker; and sending an error notification to the second BGP. The capability advertisement can include fields indicating any of (1) whether the BGP speaker can process transposed entries, (2) whether the BGP speaker can send transposed entries, and (3) a combination of both.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a flowchart of a process of transposition capability discovery according to an embodiment of the present disclosure.

FIG. 2 is a block diagram of an example implementation of a node.

FIG. 3 is a block diagram of an example processing device.

### DETAILED DESCRIPTION OF THE DISCLOSURE

Again, the present disclosure relates to systems and methods for systems and methods for signaling service Segment Identifier (SID) transposition capability in Segment Routing over Internet Protocol version 6 (SRv6) networks.

### Segment Routing Overview

Segment Routing (SR) is a technology that implements a source routing paradigm. A packet header includes a stack of function identifiers, known as segments, which define an ordered list of functions to be applied to the packet. A segment can represent any instruction, topological, or service-based. A segment can have a local semantic to an SR node or global within an SR domain. These functions include, but are not limited to, the forwarding behaviors to apply successively to the packet, notably destination-based unicast forwarding via a sequence of explicitly enumerated nodes (domain-unique node segments) and links (adjacency segments), and the like. SR allows forcing a flow through any topological path and service chain while maintaining a per-flow state only at the ingress node to the SR domain. Segment Routing is described, e.g., in Fiflsfils et al., RFC 8402, “Segment Routing Architecture,” Internet Engineering Task Force (IETF), July 2018, the contents of which are incorporated herein by reference. A particular attraction of Segment Routing is that it obviates the need to install and maintain any end-to-end (e2e) path state in the core network. Only the ingress node for a particular flow needs to hold the segment stack, which is applied as the header of every packet of that flow, to define its route through the network. This makes Segment Routing particularly suited to control by a Software-Defined Networking (SDN) model.

Segment Routing can be directly applied to Multiprotocol Label Switching (MPLS) with no change in the forwarding plane. A segment is encoded as an MPLS label. An ordered list of segments is encoded as a stack of labels. The segment to process is on the top of the stack. Upon completion of a segment, the related label is popped from the stack. Segment Routing can also be applied to the Internet Protocol (IP) v6 architecture, with a new type of routing extension header—for example, the document published in July 2015 as draft-previdi-6man-segment-routing-header (available online at tools.ietforg/html/draft-previdi-6man-segment-routing-header-08) and RFC 8754, “IPv6 Segment Routing Header (SRH),” March 2020, the contents of both are incorporated by reference herein. A segment is encoded as an IPV6 address. An ordered list of segments is encoded as an ordered list of IPV6 addresses in the routing extension header. The Segment to process at any point along the path through the network is indicated by a pointer in the routing extension header. Upon completion of a segment, the pointer is incremented. Segment Routing can also be applied to Ethernet, e.g., IEEE 802.1 and variants thereof. There are various benefits asserted for SR, including, for example, scalable end-to-end policy, easy incorporation in IP and SDN architectures, operational simplicity, a balance between distributed intelligence, centralized optimization, and application-based policy creation, and the like.

In loose source routing such as Segment Routing, a source node chooses a path and encodes the chosen path in a packet header as an ordered list of segments. The rest of the network executes the encoded instructions without any further per-flow state. Segment Routing provides full control over the path without the dependency on network state or signaling to set up a path. This makes Segment Routing scalable and straightforward to deploy. Segment Routing (SR) natively supports both IPV6 (SRv6) and MPLS (SR-MPLS) forwarding planes and can co-exist with other transport technologies, e.g., Resource Reservation Protocol (RSVP)-Traffic Engineering (RSVP-TE) and Label Distribution Protocol (LDP).

In Segment Routing, a path includes segments which are instructions a node executes on an incoming packet. For example, segments can include forward the packet according to the shortest path to the destination, forward through a specific interface, or deliver the packet to a given application/service instance). Each Segment is represented by a Segment Identifier (SID). All SIDs are allocated from a Segment Routing Global Block (SRGB) with domain-wide scope and significance, or from a Segment Routing Local Block (SRLB) with local scope. The SRGB includes the set of global segments in the SR domain. If a node participates in multiple SR domains, there is one SRGB for each SR domain. In SRv6, the SRGB is the set of global SRv6 SIDs in the SR domain.

A segment routed path is encoded into the packet by building a SID stack that is added to the packet. These SIDs are popped by processing nodes, and the next SID is used to decide forwarding decisions. A SID can be one of the following types—an adjacency SID, a prefix SID, a node SID, a binding SID, and an anycast SID. Each SID represents an associated segment, e.g., an adjacency segment, a prefix segment, a node segment, a binding segment, and an anycast segment.

An adjacency segment is a single-hop, i.e., a specific link. A prefix segment is a multi-hop tunnel that can use equal-cost multi-hop aware shortest path links to reach a prefix. A prefix SID can be associated with an IP prefix. The prefix SID can be manually configured from the SRGB and can be distributed by ISIS or OSPF. The prefix segment steers the traffic along the shortest path to its destination. A node SID is a special type of prefix SID that identifies a specific node. It is configured under the loopback interface with the loopback address of the node as the prefix. A prefix segment is a global segment, so a prefix SID is globally unique within the segment routing domain. An adjacency segment is identified by a label called an adjacency SID, which represents a specific adjacency, such as egress interface, to a neighboring router. The adjacency SID is distributed by ISIS or OSPF. The adjacency segment steers the traffic to a specific adjacency.

A binding segment represents an SR policy. A head-end node of the SR policy binds a Binding SID (BSID) to its policy. When the head-end node receives a packet with an active segment matching the BSID of a local SR Policy, the head-end node steers the packet into the associated SR Policy. The BSID provides greater scalability, network opacity, and service independence. Instantiation of the SR Policy may involve a list of SIDs. Any packets received with an active segment equal to BSID are steered onto the bound SR Policy. The use of a BSID allows the instantiation of the policy (the SID list) to be stored only on the node or nodes that need to impose the policy. The direction of traffic to a node supporting the policy then only requires the imposition of the BSID. If the policy changes, this also means that only the nodes imposing the policy need to be updated. Users of the policy are not impacted. The BSID can be allocated from the local or global domain. It is of special significance at the head-end node where the policy is programmed in forwarding.

SR Traffic Engineering (SR-TE) provides a mechanism that allows a flow to be restricted to a specific topological path, while maintaining per-flow state only at the ingress node(s) to the SR-TE path. It uses the Constrained Shortest Path First (CSPF) algorithm to compute paths subject to one or more constraint(s) (e.g., link affinity) and an optimization criterion (e.g., link latency). An SR-TE path can be computed by a head-end of the path whenever possible (e.g., when paths are confined to single IGP area/level) or at a Path Computation Engine (PCE) (e.g., when paths span across multiple IGP areas/levels).

### SRv6-Based BGP Services

Again, SRv6-based BGP services refer to the Layer-3 (L3) and Layer-2 (L2) overlay services with BGP as the service signaling protocol and SRv6 as the data-plane. The SRv6 Service SID refers to an SRv6 SID associated with one of the service specific SRv6 Endpoint Behaviors on the advertising PE router. The BGP Prefix-SID attribute (as defined in RFC 8669, “Segment Routing Prefix Segment Identifier Extensions for BGP,” December 2019, the contents of which are incorporated by reference in their entirety) is extended to carry SRv6 SIDs and their associated information with the BGP address families.

The SRv6 Service Type-Length-Values (TLVs) are defined as two new TLVs of the BGP Prefix-SID attribute to achieve signaling of SRv6 SIDs for L3 and L2 services (RFC 9252). These SRv6 Service TLVs include SRv6 Service Sub-TLVs. These SRv6 Service Sub-TLVs internally carry values of SRv6 Service Sub-Sub-TLVs. The SRv6 Service Sub-Sub-TLV of Type 1 carries the SID structure information such as Locator Node Length, Function Length, Argument Length, Transposition Length and Transposition offset.

RFC 9252 specifies a procedure called “Transposition” where part of SRv6 Function SID is transposed and carried in the MPLS label field of route's NLRI. Since the rest of the SID portion is common for the routes of the same type in the service, this procedure contributes efficient packing of routes into the same BGP update. The transposition Length 0 indicates nothing is transposed and the entire SRv6 SID value is encoded in the SID information Sub-TLV. In this case the transposition offset must be set to 0 as well. A BGP speaker that is capable of processing NLRI containing transposed SRv6 Function SID is expected to re-construct the SRv6 Function SID.

### Problem Statement

The transposition procedure involves operation at both sender and receiver sides of BGP speakers. As is known in the art, a BGP speaker is a router that advertises routers to its BGP peers, i.e., receiving BGP speakers. The receiving BGP speakers that do not support this transposition may misinterpret the part of the SRv6 SID value encoded in label field. This will cause incorrect programming to data plane with misinterpreted SRv6 Service SID value leading to complete traffic loss or misforwarding. Besides, some BGP speakers may be capable of only transposing but incapable of interpreting SRv6 Service SID or vice versa, based on inventor's observations in interoperability exercises between networking equipment from different vendors. It was determined that incorrect manual configuration can lead to BGP speakers using transposition with its peers who are not able to correctly process this feature, thereby leading to service outages.

Currently, there is no automatic way for a BGP speaker to learn its peer's transposition capabilities, leading to manual configuration on a per-neighbor and per-service basis in deployment employing routers from multiple vendors where not all routers have identical transposition capability. However, such approach is inefficient due to the amount of configuration overhead in scaled environment as well such an approach is prone to human error.

### Transposition Capability Discovery

The present disclosure includes a mechanism to allow the BGP speakers to discover this transposition capability among BGP speakers and perform the advertisement based on this discovery automatically. RFC 5492, “Capabilities Advertisement with BGP-4,” February 2009, the contents of which are incorporated by reference in their entirety, defines a mechanism to allow two BGP speakers to discover if a particular capability is supported by their BGP peer and thus whether it can be used with that peer.

The present disclosure defines a new capability that can be advertised using RFC 5492, and that can be referred to as the “SRv6 Service SID Transposition” capability, which is advertised as a capability advertisement. This capability allows BGP speakers to discover whether, for a given NLRI <Address Family Indicator (AFI)/Subsequent Address Family Indicator (SAFI)>, a peer supports SRv6 Service SID advertisement with transposition or not, as well as partial transposition.

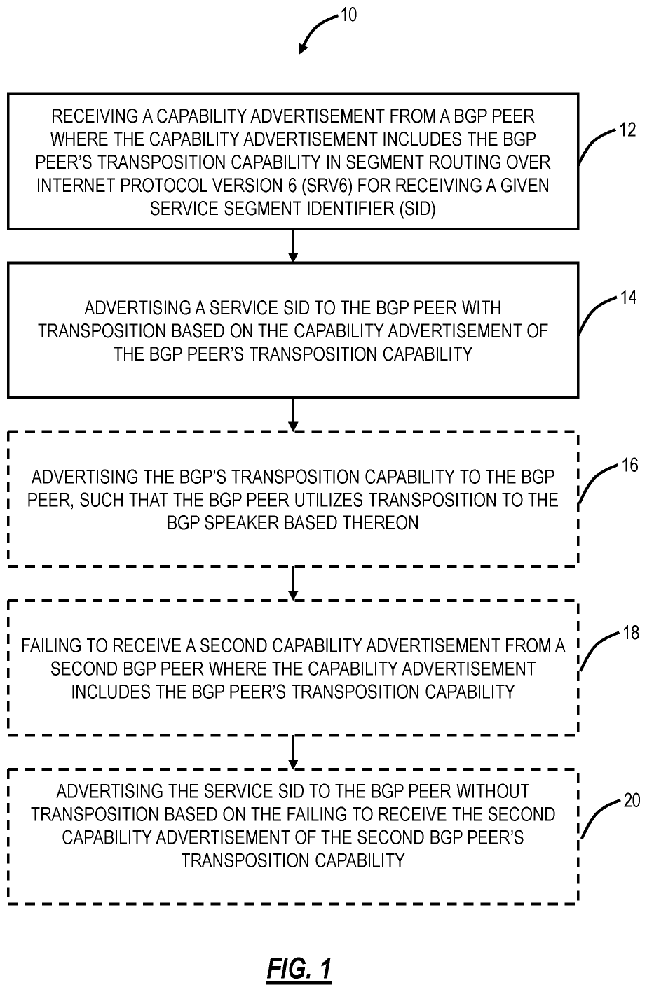

FIG. 1 is a flowchart of a process 10 of transposition capability discovery. The process 10 contemplates implementation as a method having steps; a node including a plurality of ports, switching circuitry, and a controller configured to implement the steps; and a non-transitory computer-readable medium having instructions stored thereon for programming a node to perform the steps. The process 10 is described as being implemented by a BGP speaker.

The process 10 includes receiving a capability advertisement from a BGP peer where the advertisement includes the BGP peer's transposition capability in Segment Routing over Internet Protocol version 6 (SRv6) for receiving a given service Segment Identifier (SID) (step 12); and advertising a service SID to the BGP peer with transposition based on the capability advertisement of the BGP peer's transposition capability (step 14). The process 10 can further include advertising the BGP's transposition capability to the BGP peer, such that the BGP peer utilizes transposition to the BGP speaker based thereon (step 16). The process 10 can further include failing to receive a second capability advertisement from a second BGP peer where the capability advertisement includes the BGP peer's transposition capability (step 18); and advertising the service SID to the BGP peer without transposition based on the failing to receive the second capability advertisement of the second BGP peer's transposition capability (step 20).

A BGP speaker that can receive SRv6 Service SID TLVs with transposition from its peer or would like to send SRv6 Service SID TLVs using transposition procedure can advertise the SRv6 Service SID transposition capability to the peer using BGP capability advertisement. While advertising the SRv6 Service SID, the sending speaker will encode the TLVs using transposition procedure only if the peer has exchanged the SRv6 Service SID Transposition capability for receiving it. If the receiving speaker has not exchanged this capability, then the sender should encode the entire SID value in the information Sub-TLV and set the transposition Length and offset to 0.

When the speaker has exchanged this capability for receiving, then it should be able to process the transposed label value and SID part to form the correct Function SID value. If the speaker has not exchanged this capability, but the receiving the NLRI with transposition length and offset with non-zero values, it will be treated as Error condition as explained below.

The capability advertisement can include an Address Family Indicator (AFI), a Subsequent Address Family Indicator (SAFI), and a field indicative of the BGP peer's transposition capability. In an embodiment, the capability advertisement is per RFC 5492. For example, a BGP speaker that wishes to advertise to a BGP Peer on a certain capability can use the capability advertisement procedure as per RFC 5492. This can be referred to as a ‘SRv6 Service SID Transposition Capability’ that is a new BGP capability, defined as follows; of course, there can be other names. This can be an optional parameter that is used by a BGP speaker to convey to its BGP peer this is supported by the speaker. The encoding of BGP optional parameters is specified in RFC4271. The parameter type of the capabilities optional parameter is 2.

In an embodiment, the fields in the capabilities optional parameter can be set as follows: The capability code field can be set to some value which indicates the SRv6 Service SID Transposition Capability. (Note: this code can be Internet Assigned Numbers Authority (IANA) assigned), such as from an unassigned value, and the unassigned ranges are 10-63, 74-127, 132-183, 186-238).

The capability length field is set to a variable value that is the length of the capability value field (which follows in an embodiment). The capability value field can have the following format:

NLRI AFI - 1 (2 octets)
NLRI SAFI - 1 (2 octets)
Send/Receive (1 octet)

The Address Family Identifier (AFI), Subsequent Address Family Identifier (SAFI): The AFI and SAFI, taken in combination, indicate that “SRv6 Service SID Transposition” is supported for routes that are advertised with the same AFI and SAFI. The Send/Receive field indicates whether the sender is (a) can process transposed NLRI entries from its peer (value 1), (b) can send the NLRIs using transposed procedure (c) both (value 3). In an embodiment, the BGP peer's transposition capability can include whether the BGP peer can process transposed Network Layer Reachability Information (NLRI) entries, can send the NLRIs entries using transposition, and a combination thereof.

The process 10 can further include receiving a second service SID from a second BGP peer with the second service SID having transposition and where the second BGP peer has not provided the capability advertisement of the BGP peer's transposition capability to the BGP speaker; and sending an error notification to the second BGP. When the SRv6 Service SID Transposition Capability is not advertised by the peer, but it is receiving the NLRIs with transposed values, then it should be treated as Update Message Error Handling in RFC 4271, “A Border Gateway Protocol 4 (BGP-4),” January 2006, the contents of which are incorporated by reference in their entirety. When the error is detected, it should be indicated by sending the NOTIFICATION message with Error Code UPDATE Message Error. The error subcode will elaborate on the specific nature of the error. Since it is an optional attribute, the attribute will be discarded, and the Error Subcode will be set to Optional Attribute Error. The data field will contain the attribute (type, length, and value).

### Example Node

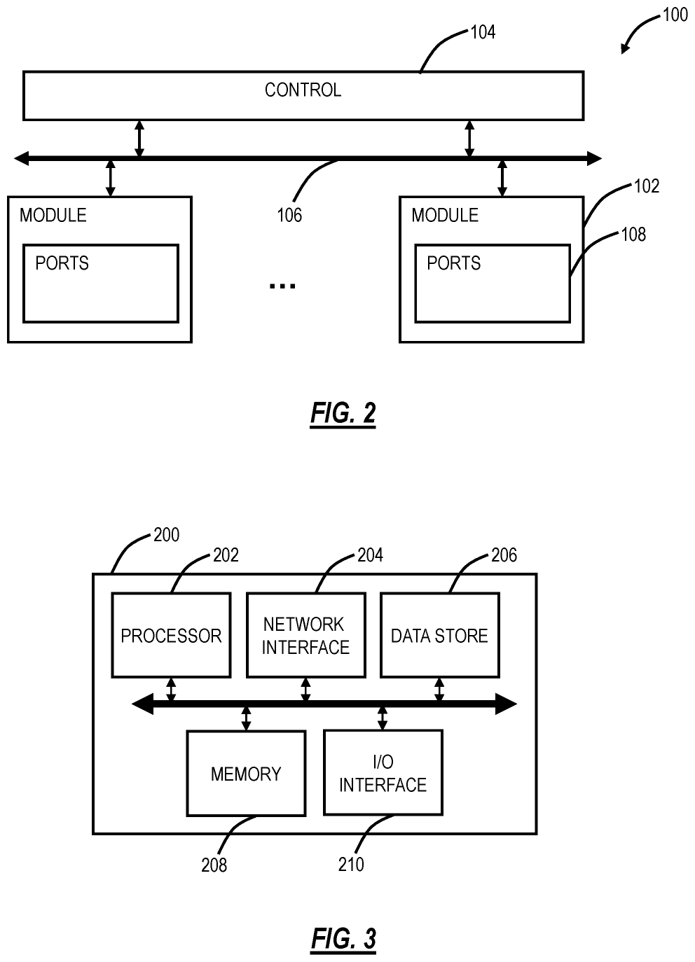

FIG. 2 is a block diagram of an example implementation of a node 100, such as a router, a BGP speaker, a BGP peer, and the like Those of ordinary skill in the art will recognize FIG. 2 is a functional diagram in an oversimplified manner, and a practical embodiment may include additional components and suitably configured processing logic to support known or conventional operating features that are not described in detail herein.

In an embodiment, the node 100 is a packet switch, but those of ordinary skill in the art will recognize the systems and methods described herein can operate with other types of network elements and other implementations that support SR networking. In this embodiment, the node 100 includes a plurality of modules 102, 104 interconnected via an interface 106. The modules 102, 104 are also known as blades, line cards, line modules, circuit packs, pluggable modules, etc. and generally refer to components mounted on a chassis, shelf, etc. of a data switching device, i.e., the node 100. Each of the modules 102, 104 can include numerous electronic devices and/or optical devices mounted on a circuit board along with various interconnects, including interfaces to the chassis, shelf, etc.

Two example modules are illustrated with line modules 102 and a control module 104. The line modules 102 include ports 108, such as a plurality of Ethernet ports. For example, the line module 102 can include a plurality of physical ports disposed on an exterior of the module 102 for receiving ingress/egress connections. Additionally, the line modules 102 can include switching components to form a switching fabric via the interface 106 between all of the ports 108, allowing data traffic to be switched/forwarded between the ports 108 on the various line modules 102. The switching fabric is a combination of hardware, software, firmware, etc. that moves data coming into the node 100 out by the correct port 108 to the next node 100. “Switching fabric” includes switching units in a node; integrated circuits contained in the switching units; and programming that allows switching paths to be controlled. Note, the switching fabric can be distributed on the modules 102, 104, in a separate module (not shown), integrated on the line module 102, or a combination thereof.

The control module 104 can include a microprocessor, memory, software, and a network interface. Specifically, the microprocessor, the memory, and the software can collectively control, configure, provision, monitor, etc. the node 100. The network interface may be utilized to communicate with an element manager, a network management system, the PCE 20, etc. Additionally, the control module 104 can include a database that tracks and maintains provisioning, configuration, operational data, and the like.

Again, those of ordinary skill in the art will recognize the node 100 can include other components which are omitted for illustration purposes, and that the systems and methods described herein are contemplated for use with a plurality of different network elements with the node 100 presented as an example type of network element. For example, in another embodiment, the node 100 may include corresponding functionality in a distributed fashion. In a further embodiment, the chassis and modules may be a single integrated unit, namely a rack-mounted shelf where the functionality of the modules 102, 104 is built-in, i.e., a “pizza-box” configuration. That is, FIG. 2 is meant to provide a functional view, and those of ordinary skill in the art will recognize actual hardware implementations may vary.

### Example Controller

FIG. 3 is a block diagram of an example processing device 200. The processing device 200 can be part of the network element, or a stand-alone device communicatively coupled to the network element. Also, the processing device 200 can be referred to in implementations as a control module, a shelf controller, a shelf processor, a system controller, etc. The processing device 200 can include a processor 202 which is a hardware device for executing software instructions. The processor 202 can be any custom made or commercially available processor, a central processing unit (CPU), an auxiliary processor among several processors associated with the processing device 200, a semiconductor-based microprocessor (in the form of a microchip or chipset), or generally any device for executing software instructions. When the processing device 200 is in operation, the processor 202 is configured to execute software stored within the memory, to communicate data to and from the memory, and to generally control operations of the processing device 200 pursuant to the software instructions. The processing device 200 can also include a network interface 204, a data store 206, memory 208, an I/O interface 210, and the like, all of which are communicatively coupled to one another and to the processor 202.

The network interface 204 can be used to enable the processing device 200 to communicate on a data communication network, such as to communicate to a management system, to the nodes 12, the like. The network interface 204 can include, for example, an Ethernet module. The network interface 204 can include address, control, and/or data connections to enable appropriate communications on the network. The data store 206 can be used to store data, such as control plane information, provisioning data, Operations, Administration, Maintenance, and Provisioning (OAM&P) data, etc. The data store 206 can include any of volatile memory elements (e.g., random access memory (RAM, such as DRAM, SRAM, SDRAM, and the like)), nonvolatile memory elements (e.g., ROM, hard drive, flash drive, CDROM, and the like), and combinations thereof. Moreover, the data store 206 can incorporate electronic, magnetic, optical, and/or other types of storage media. The memory 208 can include any of volatile memory elements (e.g., random access memory (RAM, such as DRAM, SRAM, SDRAM, etc.)), nonvolatile memory elements (e.g., ROM, hard drive, flash drive, CDROM, etc.), and combinations thereof. Moreover, the memory 208 may incorporate electronic, magnetic, optical, and/or other types of storage media. Note that the memory 208 can have a distributed architecture, where various components are situated remotely from one another, but may be accessed by the processor 202. The I/O interface 210 includes components for the processing device 200 to communicate with other devices.

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A Border Gateway Protocol (BGP) speaker comprising circuitry configured to:
receive a capability advertisement from a BGP peer where the capability advertisement includes the BGP peer's transposition capability in Segment Routing over Internet Protocol version 6 (SRv6) for receiving a given service Segment Identifier (SID), and
advertise a service SID to the BGP peer with transposition based on the capability advertisement of the BGP peer's transposition capability.

2. The BGP speaker of claim 1, wherein the circuitry is further configured to
advertising the BGP's transposition capability to the BGP peer, such that the BGP peer utilizes transposition to the BGP speaker based thereon.

3. The BGP speaker of claim 1, wherein the circuitry is further configured to
failing to receive a second capability advertisement from a second BGP peer where the capability advertisement includes the BGP peer's transposition capability, and
advertising the service SID to the BGP peer without transposition based on the failing to receive the second capability advertisement of the second BGP peer's transposition capability.

4. The BGP speaker of claim 1, wherein the capability advertisement includes an Address Family Indicator (AFI), a Subsequent Address Family Indicator (SAFI), and a field indicative of the BGP peer's transposition capability.

5. The BGP speaker of claim 4, wherein the capability advertisement is per RFC 5492.

6. The BGP speaker of claim 1, wherein the BGP peer's transposition capability includes whether the BGP peer can process transposed Network Layer Reachability Information (NLRI) entries, can send the NLRIs entries using transposition, and a combination thereof.

7. The BGP speaker of claim 1, wherein the circuitry is further configured to
receiving a second service SID from a second BGP peer with the second service SID having transposition and where the second BGP peer has not provided the capability advertisement of the BGP peer's transposition capability to the BGP speaker, and
sending an error notification to the second BGP.

8. The BGP speaker of claim 1, wherein the capability advertisement includes fields indicating any of (1) whether the BGP speaker can process transposed entries, (2) whether the BGP speaker can send transposed entries, and (3) a combination of both.

9. A method implemented by a Border Gateway Protocol (BGP) speaker, the method comprising steps of:
receiving a capability advertisement from a BGP peer where the capability advertisement includes the BGP peer's transposition capability in Segment Routing over Internet Protocol version 6 (SRv6) for receiving a given service Segment Identifier (SID); and
advertising a service SID to the BGP peer with transposition based on the capability advertisement of the BGP peer's transposition capability.

10. The method of claim 9, wherein the steps further include
advertising the BGP's transposition capability to the BGP peer, such that the BGP peer utilizes transposition to the BGP speaker based thereon.

11. The method of claim 9, wherein the steps further include
failing to receive a second capability advertisement from a second BGP peer where the capability advertisement includes the BGP peer's transposition capability; and
advertising the service SID to the BGP peer without transposition based on the failing to receive the second capability advertisement of the second BGP peer's transposition capability.

12. The method of claim 9, wherein the capability advertisement includes an Address Family Indicator (AFI), a Subsequent Address Family Indicator (SAFI), and a field indicative of the BGP peer's transposition capability.

13. The method of claim 12, wherein the capability advertisement is per RFC 5492.

14. The method of claim 9, wherein the BGP peer's transposition capability includes whether the BGP peer can process transposed Network Layer Reachability Information (NLRI) entries, can send the NLRIs entries using transposition, and a combination thereof.

15. The method of claim 9, wherein the steps further include
receiving a second service SID from a second BGP peer with the second service SID having transposition and where the second BGP peer has not provided the capability advertisement of the BGP peer's transposition capability to the BGP speaker; and
sending an error notification to the second BGP.

16. The method of claim 9, wherein the capability advertisement includes fields indicating any of (1) whether the BGP speaker can process transposed entries, (2) whether the BGP speaker can send transposed entries, and (3) a combination of both.

17. A non-transitory computer-readable medium comprising instructions that, when executed, cause circuitry in a Border Gateway Protocol (BGP) speaker to perform steps of:
receiving a capability advertisement from a BGP peer where the capability advertisement includes the BGP peer's transposition capability in Segment Routing over Internet Protocol version 6 (SRv6) for receiving a given service Segment Identifier (SID); and
advertising a service SID to the BGP peer with transposition based on the capability advertisement of the BGP peer's transposition capability.

18. The non-transitory computer-readable medium of claim 17, wherein the steps further include
advertising the BGP's transposition capability to the BGP peer, such that the BGP peer utilizes transposition to the BGP speaker based thereon.

19. The non-transitory computer-readable medium of claim 17, wherein the steps further include
failing to receive a second capability advertisement from a second BGP peer where the capability advertisement includes the BGP peer's transposition capability; and
advertising the service SID to the BGP peer without transposition based on the failing to receive the second capability advertisement of the second BGP peer's transposition capability.

20. The non-transitory computer-readable medium of claim 17, wherein the capability advertisement includes an Address Family Indicator (AFI), a Subsequent Address Family Indicator (SAFI), and a field indicative of the BGP peer's transposition capability.
